(19) United States
(12) Patent Application Publication
(10) Pub. No.: US 2025/0382978 A1
(43) Pub. Date: Dec. 18, 2025

(54) BAND(S) ON GAS CHARGED CARTRIDGES THAT ARE ELONGATED RELATIVE TO BONDING REGION OR WELDED

(71) Applicant: Performance Pulsation Control, Inc., Richardson, TX (US)

(72) Inventors: James Barlow, Dallas, TX (US); John Thomas Rogers, Garland, TX (US)

(21) Appl. No.: 19/238,258

(22) Filed: Jun. 13, 2025

Related U.S. Application Data
(60) Provisional application No. 63/659,716, filed on Jun. 13, 2024.

(51) Int. Cl. F15B 1/02

(52) U.S. Cl. CPC F15B 1/021

(57) ABSTRACT

To improve effectiveness of gas charged cartridges in attenuating pressure pulsations, increased pre-charge pressure is desirable. To address deficiencies in current cartridges that limit sustainable charge pressure before containment of the gas charge is lost, bands securing ends of the cartridge elastomeric body to the plug and head are one or both of elongated relative to a length of a bonding material between the body and the plug or a protrusion on the head, or welded to the plug or head protrusion. The elongated bands inhibit ballooning of the elastomeric body around an edge of the band, stressing the bond and increasing risk of gas leaks in the region of the bond. The welds inhibit shear forces on the bond.

### CROSS-REFERENCE TO RELATED APPLICATION AND PRIORITY CLAIM

This application claims priority under 35 U.S.C. § 119 (e) to U.S. Provisional Patent Application No. 63/659,716 filed on Jun. 13, 2024, which is hereby incorporated by reference in its entirety.

### TECHNICAL FIELD

This disclosure relates generally to pulsation control during the operation of reciprocating pump fluid transfer systems. More specifically, this disclosure relates to pulsation control products with gas charged cartridges having banded ends.

### BACKGROUND

Pulsation control in reciprocating pump fluid transfer systems is in constant need of improvement. Among the desirable improvements are reduced pulsation amplitudes to the pumps and from pumps to the downstream system as well as greater flexibility in integration of pulsation control dampeners with other elements of an overall pump system. In particular, it is desirable to achieve higher cartridge pre-charge pressures while remaining interchangeable with existing cartridge devices.

### SUMMARY

To improve the ability of gas charged cartridges to attenuate system pulsations, an increase of the pre-charge pressure is desirable. For example, gas charge containment loss occurs when stress in the annular elastomeric body reaches a critical level at which material failure occurs. This failure most frequently occurs in a region defined as a “transition zone” (or “transition area”), which is between the annular elastomeric body bonded to the inserted head or plug and the area where the annular elastomeric body, once charged with gas, reaches an expanded diameter that may induce primarily radial forces (as well as secondary, longitudinal forces) on the bond material.

To address deficiencies that limit the sustainable charge pressure in current gas charged cartridges before gas charge containment is lost, bands securing both ends of the annular elastomeric cartridge body to the plug and the head are employed, with features preventing or inhibiting shear of the elastomeric cartridge body from the bond material and/or of the bond material from the underlying inserted head or plug.

In some embodiments, the bands are made elongated relative to a length of a bonding material between the elastomeric body and the plug or a protrusion on the head, protecting the interfaces of bonding material with the elastomeric body and with the plug or a protrusion on the head from stress under load in the transition area. The bands may be elongated relative to the bonding region. Such elongated bands extend or project past the region of bonding between the annular elastomeric body and the structure inserted therein, by an amount equal to or greater than the transition zone. The elongated bands may be composed of both a crimped area and a cylindrical, non-crimped area which closely approximates the outer diameter (OD) of the elastomeric body. The cylindrical, non-crimped area of the elongated bands extends past an edge of the bonding region, either by extension of the band beyond an edge of the plug or the head protrusion or by termination of the bonding material underlying the band at a location offset from the band edge and beneath the band. The elongated bands inhibit ballooning of the elastomeric body around an edge of the band, stressing the bond and increasing risk of gas leaks in the region of the bond.

In some embodiments, the bands are welded to the plug or a protrusion on the head, again protecting the annular elastomeric body from stress under load, but at the end opposite the transition area. The weld contributes to fixing the position of the bands relative to the plug or a protrusion on the head, even under the stress of charge pressure on the bond region, which may induce longitudinal shear forces

In some embodiments, a cartridge for a pulsation control device includes an annular elastomeric body. A first end insert within a first end of the annular elastomeric body is chemically bonded to the annular elastomeric body by a bonding material. A band further secures the annular elastomeric body to the first end insert, where the band is one or both of elongated or secured by welding. Elongated bands extend or project past the edge of the bond between the first end insert and the annular elastomeric body. Welding contributes to fixing the band position relative to the first end insert.

In some embodiments, the bonding material may end at or before an edge of the first end insert, and the band may extend past the edge of the first end insert.

In some embodiments, an amount by which the band extends past the edge of the first end insert may be equal to or greater than a length of the bonding material.

In some embodiments, the first end insert may be a plug.

In some embodiments, the first end insert may be a protrusion on a cartridge head.

In some embodiments, an edge of the band may be offset from an end of the annular elastomeric body.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “include” and “comprise” as well as derivatives thereof, mean inclusion without limitation. The term “or” is inclusive, meaning and/or. The phrase “associated with” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C. The terms dampener and stabilizer may be used interchangeably. The terms pulsation dampener, dampeners, suction dampener, suction stabilizer, or stabilizers may be used interchangeably.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of a pump pulsation control suction stabilizer and a pump pulsation control discharge dampener, either or both including an elongated crimped band, on a pump system according to various embodiments of the present disclosure;

FIG. 2 illustrates a cut away view of a pulsation control device within the pump system of FIG. 1, with a gas charged cartridge;

FIG. 3 illustrates an alternative cartridge design for a gas charged pulsation control device within the pump system of FIG. 1;

FIGS. 4A and 4B illustrate, in greater detail, sectional views of the elongated bands on gas charged cartridges of the type illustrated in FIGS. 2 and 3, for use in a suitable pulsation control device;

FIGS. 5, 6, and 7 diagrammatically illustrate relative dimensions for a band and bonding material securing the elastomeric body of a cartridge to an insert;

FIGS. 8, 9, and 10 diagrammatically illustrate crimping of a band over bonding material securing the elastomeric body of a cartridge to an insert;

FIGS. 11A and 11B, FIGS. 12A and 12B, and FIGS. 13A and 13B depict comparative embodiments of a pulsation control device cartridge having standard and elongated bands; and

FIGS. 14A and 14B, FIGS. 15A and 15B, and FIGS. 16A and 16B illustrate sectional views of the bands on gas charged cartridges of the type illustrated in FIGS. 2 and 3 with welds on the bands, for use in a suitable pulsation control device.

### DETAILED DESCRIPTION

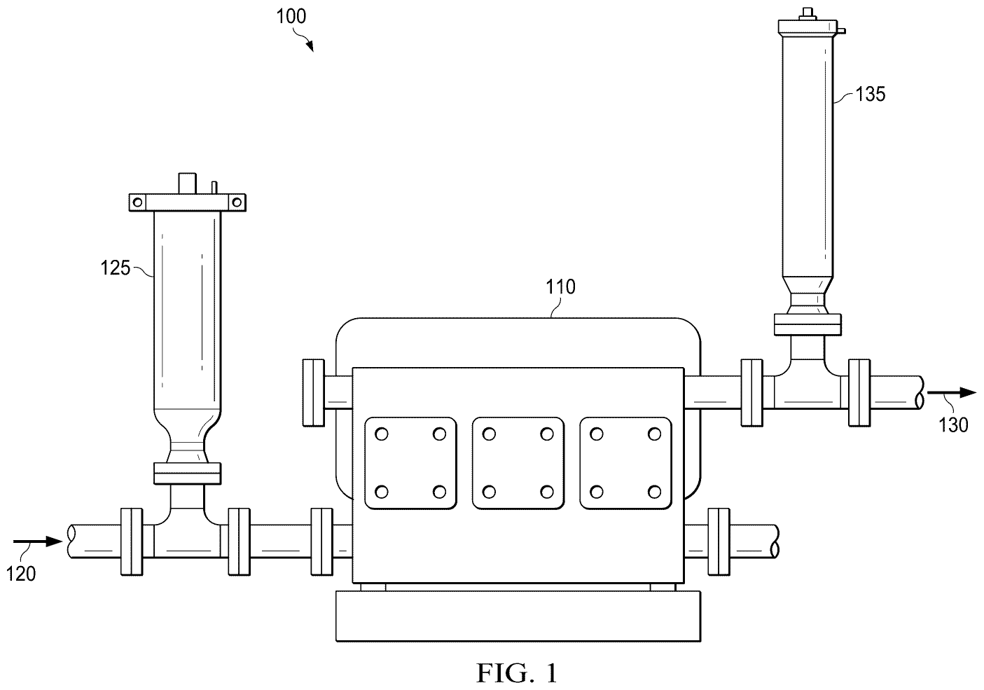

FIGS. 1 through 16B, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably-arranged structure that can be used to control or partially control pumped fluid pulsation amplitudes.

FIG. 1 illustrates an example of a pump pulsation control suction stabilizer and a pump pulsation control discharge dampener, either or both including an elongated band, on a pump system according to various embodiments of the present disclosure. The embodiment illustrated in FIG. 1 is for illustration and explanation only. FIG. 1 does not limit the scope of this disclosure to any particular implementation.

In particular, FIG. 1 illustrates a fluid delivery and pulsation control system 100 according to various embodiments of the present disclosure. FIG. 1 illustrates an example location of a pulsation control suction stabilizer 125 and a pulsation control discharge dampener 135 in relation to a pump 110. Pump 110 is a reciprocating pump system.

Fluid enters the pump 110 at inlet 120 and exits the pump at discharge 130. Inlet 120 is referred to as the suction end of the pump 110, as the fluid is sucked into the pump, and the fluid is discharged via discharge 130 to downstream components and equipment. Pulsation control suction stabilizer 125 stabilizes and dampens the fluid as it enters the pump 110, while the pulsation control discharge dampener 135 stabilizes and dampens the fluid as the fluid exits the pump 110. Pulsation control suction stabilizer 125 dampens fluid prior to entering the pump 110 to provide a steady flow of the fluid into the pump 110. Pulsation control suction stabilizer 125 also reduces pulsation levels in the manifold and inside the pump. Pulsation control discharge dampener 135 dampens fluid pulsations inside the pump and pump manifold, and as the fluid exits the pump, to provide reduced pulsation and flow variations towards the downstream equipment and components. In certain embodiments, pulsation control suction stabilizer 125 or pulsation control discharge dampener 135 is omitted from the pulsation control system 100.

Pulsation control stabilizers 125 and 135 are sized based on the capacity of the pump 110, the fluid type, the temperature of the fluid, the operating system pressure, the diameter of the plunger or piston of the pump 110, the stroke length of the pump 110, and the like. Pulsation control stabilizers 125 and 135 can be sized differently.

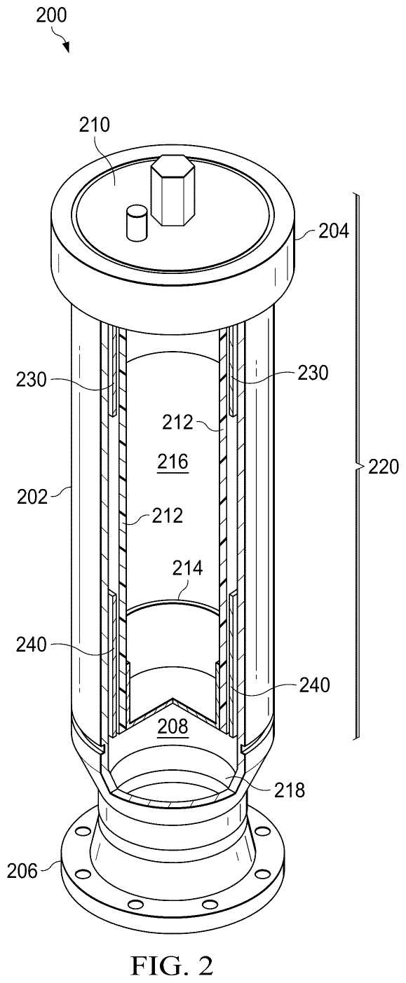

FIG. 2 illustrates a cut away view of a pulsation control device within the pump system of FIG. 1, with a gas charged cartridge. The embodiment illustrated in FIG. 2 is for illustration and explanation only. FIG. 2 does not limit the scope of this disclosure to any particular implementation.

FIG. 2 illustrates a pulsation control device 200 utilizing a replaceable and/or refillable gas charged cartridge. Pulsation control device 200 may be one of pulsation control suction stabilizer 125 or pulsation control discharge dampener 135. Pulsation control device 200 includes a generally cylindrical body 202 with a top ring 204 and a flange connection 206. An internal volume 208 of the body 202 receives a cartridge 220 including a head 210 with a projection (not visible), an annular elastomeric body 212 formed of a composite elastomeric material, and a plug 214, which are sealed to retain compressed or pressurized gas within an internal volume 216 of the cartridge 220. The cartridge 220, which is formed by the combination of the head 210, the elastomeric body 212, and the plug 214, is inserted inside the body 202 of the pulsation control device 200. The body 202 of the pulsation control device 200 is sealed to prevent the escape of the fluid from the system 100 through (for example) an upper opening of the body 202 into which the cartridge 220 is inserted. In certain embodiments, the top ring 204 and the head 210 fit flush.

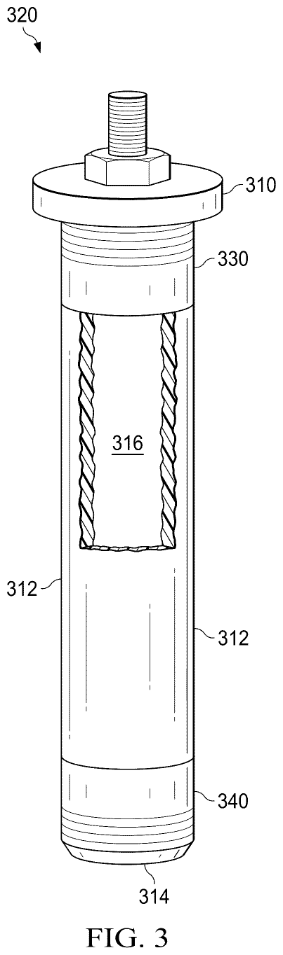

Pulsation control device 200 sits on a pipe (not shown in FIG. 3) in a piping system for the fluid delivery and pulsation control system 100, and is connected to that pipe at the flange connection 206. Pumped fluid from that pipe enters the pulsation control device 200 through opening 218 extending through the flange connection 206. The pumped fluid travels upwards and downwards through opening 218 and inside the internal volume 208, including within an area between the cartridge 220 and the inner circumference of the body 202 defining the internal volume 208. The fluid traveling inside the body 202 and outside the cartridge 220 transmits pressure pulsations to the gas filled cartridge 220. The gas filled cartridge 220 compresses and expands as the cartridge 220 absorbs the pressure pulsations created by the reciprocating action of the pump. By absorbing or attenuating the pressure pulsations, the pressure pulsations within the fluid are dampened.

The head 210, the annular elastomeric body 212, and the plug 214 form the cartridge 220. The elastomeric body 212 of the cartridge 220 is secured to a projection from the head 210 by a bonding material (not visible) and a band 230. The elastomeric body 212 of the cartridge 220 is secured to the plug 214 by a bonding material (not visible) and a band 240. While not illustrated in FIG. 2, at least a portion of the band 230 and/or the band 240 may be crimped.

FIG. 3 illustrates an alternative cartridge design for a gas charged pulsation control device within the pump system of FIG. 1. The embodiment illustrated in FIG. 3 is for illustration and explanation only. FIG. 3 does not limit the scope of this disclosure to any particular implementation.

FIG. 3 illustrates a cartridge 320 that may be used with a suitable pulsation control device (not shown but, e.g., one of pulsation control suction stabilizer 125 or pulsation control discharge dampener 135). Cartridge 320 includes a generally cylindrical elastomeric body 312 with an internal volume 316. The internal volume 316 is sealed to retain pressurized gas therein. The internal volume 316 of the cartridge 320 is enclosed by a metallic head 310, the annular elastomeric body 312 formed of a composite elastomeric material, and the plug 314 (which, in the embodiment of FIG. 3, has a tapered rather than square end).

During use, the bottom portion of the cartridge 320 is inserted inside the body of the pulsation control device in a manner similar to insertion of cartridge 220 into pulsation control device 200. A top portion of the head 310 may be above a top ring for the pulsation control device. Similar to the description above, the pulsation control device receiving the cartridge 320 sits on a pipe in a piping system for the fluid delivery and pulsation control system 100, and is connected to that pipe at the flange connection, analogous to the embodiment depicted in FIG. 2. Pumped fluid enters the pulsation control device via an opening through a (tapered) bottom and neck connected to the flange. The fluid travels upwards and downwards through that opening and inside the internal volume of the pulsation control device, including within an area between the cartridge 320 and the inner circumference of the body for the pulsation control device. The fluid traveling inside the pulsation control device body and outside the cartridge 320 transmits pressure pulsations to the gas filled cartridge 320. The gas filled cartridge 320 compresses and expands as the cartridge 320 absorbs and/or attenuates the pressure pulsations created by the reciprocating action of the pump. By absorbing or attenuating the pressure pulsations, the pressure pulsations within the fluid are dampened.

The head 310, the annular elastomeric body 312, and the plug 314 form the cartridge 320. The elastomeric body 312 of the cartridge 320 is secured to a projection from the head 310 by a bonding material (not visible) and a band 330. The elastomeric body 312 of the cartridge 320 is secured to the plug 314 by a bonding material (not visible) and a band 340. As illustrated in FIG. 3, at least a portion of the band 330 and/or the band 340 may be crimped.

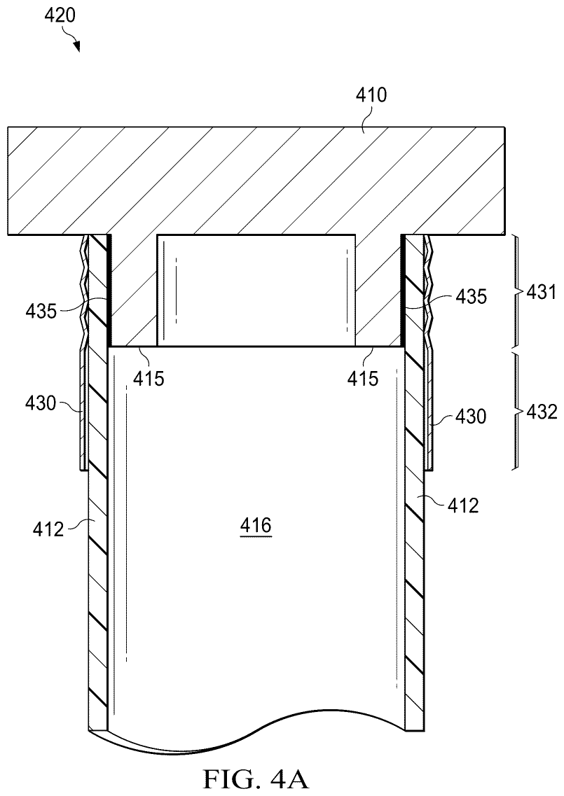

FIGS. 4A and 4B illustrate, in greater detail, sectional views of the elongated bands on gas charged cartridges of the type illustrated in FIGS. 2 and 3, for use in a suitable pulsation control device (not shown but, e.g., one of pulsation control suction stabilizer 125 or pulsation control discharge dampener 135). The embodiment illustrated in FIGS. 4A and 4B is for illustration and explanation only. FIGS. 4A and 4B do not limit the scope of this disclosure to any particular implementation. In FIGS. 4A and 4B, cartridge 420 includes a generally cylindrical elastomeric body 412 with an internal volume 416. The internal volume 416 of the cartridge 420 is enclosed by a metallic head 410, the annular elastomeric body 412 formed of a composite elastomeric material, and a plug 414. The internal volume 416 is sealed to retain pressurized gas therein.

As shown in FIG. 4A, the elongated band 430 secures a first end of the annular, elastomeric body 412 of a cartridge 420 to a hollow (annular) protrusion 415 from the head 410. A bonding material 435 (suitable chemical compositions of which are known in the art) also secures a portion of the first end of the annular, elastomeric body 412 to the protrusion 415. The bonding material 435 may seal the first end of the annular, elastomeric body 412 to the protrusion 415, to retain pressurized gas within the internal volume 416. The elongated band 430 includes a crimped portion 431 having a wavy surface as a result of being pinched inward at various locations and an uncrimped portion 432 having a smooth surface. The uncrimped portion 432 of the elongated band 430 may be slightly spaced apart from the annular, elastomeric body 412.

As shown in FIG. 4B, the elongated crimped band 440 secures a second end of the annular, elastomeric body 412 of a cartridge to a hollow (annular) plug 414. A bonding material 445 (having a similar chemical composition as bonding material 435) also secures a portion of the second end of the annular, elastomeric body 412 to the plug 414. The bonding material 445 may seal the second end of the annular, elastomeric body 412 to the plug 414, to retain pressurized gas within the internal volume 416. The elongated band 440 includes a crimped portion 441 having a wavy surface as a result of being pinched inward at various locations and an uncrimped portion 442 having a smooth surface. The uncrimped portion 442 of the elongated band 440 may be slightly spaced apart from the annular, elastomeric body 412.

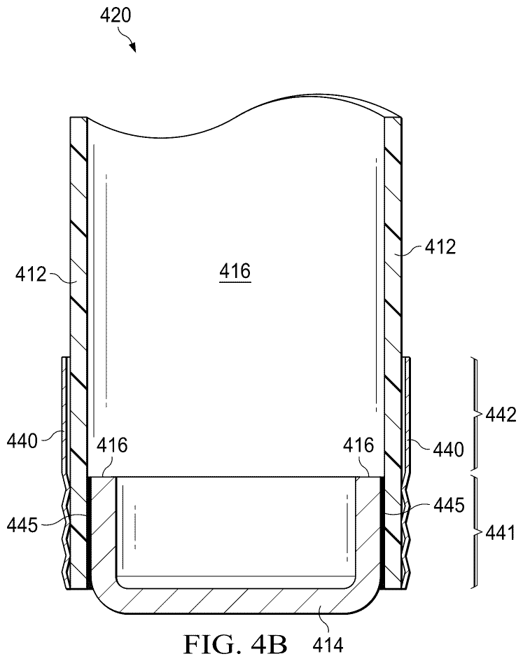

FIGS. 5, 6, and 7 diagrammatically illustrate relative dimensions for a band and bonding material securing the elastomeric body of a cartridge to a plug. The relative dimensions for the band and bonding material are illustrated independent of crimping of the band to form crimped portions 431, 441 and leave uncrimped portions 432, 442 as described. While illustrated for a band securing the elastomeric body of a cartridge to a plug as depicted in FIG. 4B, the same issues apply to a band securing the elastomeric body of a cartridge to a protrusion from the head as depicted in FIG. 4A. Accordingly, those skilled in the art will recognize that the same features described in connection with securing the annular, elastomeric body 512, 612, 712 of a cartridge 520, 620, 720 to a hollow plug 514, 614, 714 also apply to securing the other end of the annular, elastomeric body 512, 612, 712 to a cartridge head (not shown).

In FIG. 5, the elastomeric body 512 is secured to the plug 514 by bonding material 555, sealing an interior volume 516 of the cartridge 520 to retain pressurized gas therein. A band 540 also secures the elastomeric body 512 to the plug 514. A portion of the band 540 may be crimped. A length 560 of the bonding material 555 is approximately equal to or greater than a width of the band 540. For example, a width of the band 540 may be approximately four inches, and the length 560 of the bonding material 555 may be approximately equal to or greater than that dimension. With such an arrangement, a potential for strain on the bond created by the bonding material 555 between the wall of the elastomeric body 512 and the plug 514 exists. As the pressure of gas inside the interior volume 516 increases, the portion of the wall of the elastomeric body 512 above the upper edge of the band 540 will tend to expand and “balloon” outward. At high pre-charge pressures, at or in excess of 10,000 pounds per square inch (psi), the elastomeric body 512 may balloon significantly. The outward force on the wall of the elastomeric body 512 caused by the high pre-charge pressure creates stress on the innermost edge of the bond created by the bonding material 555 between the elastomeric body 512 and the plug 514—that is, the edge farthest from the end of the elastomeric body 512 and closest to an end of the insert (plug or head protrusion) inserted into the elastomeric body 512. The stress on the bonding material 555 is a source of possible tears and/or leaks, allowing the pressurized gas to escape from the interior volume 516 of the cartridge 520. For example, the stress may cause the bonding material 555 to delaminate from either the metal of the plug 514 or the material of the elastomeric body 512, or may cause tearing in the wall of the inner diameter of the elastomeric body 512. Reduction in pre-charge pressure from leaks degrades effectiveness of the cartridge 520 in dampening pressure pulsations within pumped fluid.

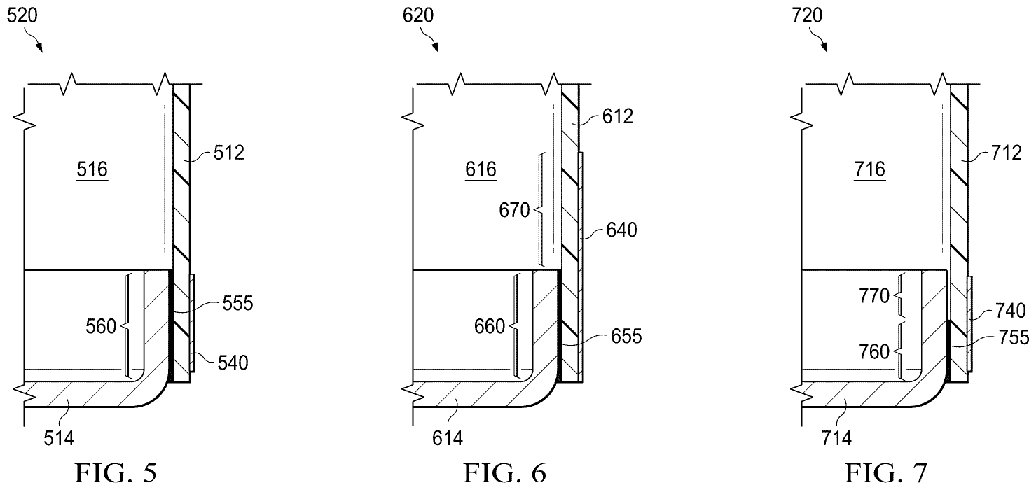

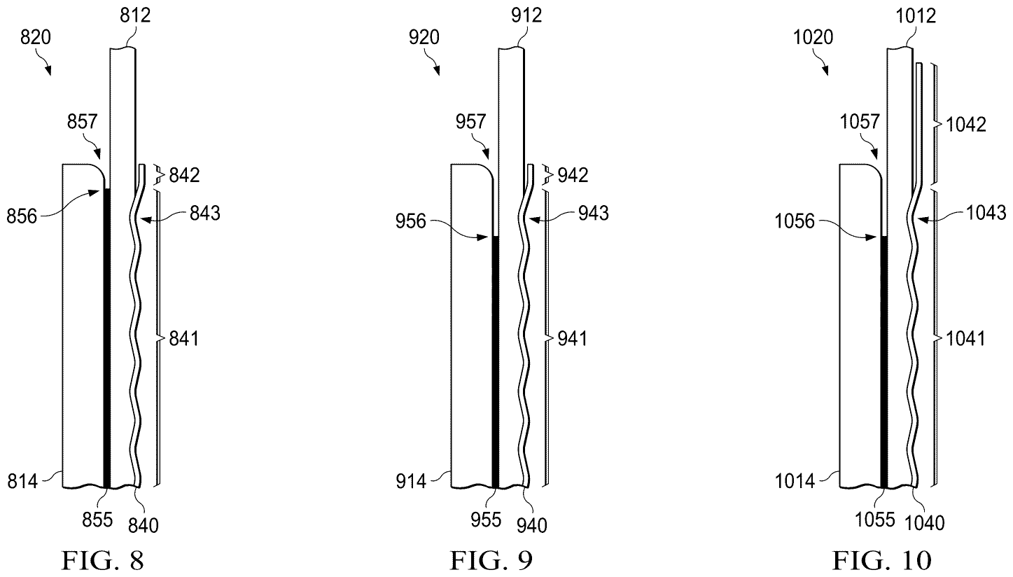

In the embodiments of FIGS. 6 and 7, stress on the bonding material is reduced by making the band elongated relative to a length of the bonding material. In FIG. 6, elongation is achieved by increasing a width of the band. In FIG. 6, the elastomeric body 612 is secured to the plug 614 by bonding material 655, sealing an interior volume 616 of the cartridge 620 to retain pressurized gas therein. A band 640 also secures the elastomeric body 612 to the plug 614. A width of the band 640 is greater than a length 660 of the bonding material 655, which reduces stress at the edge of the bond created by the bonding material 655. For example, a width of the band 640 may be approximately ten inches, while the length 660 of the bonding material 655 may be approximately four inches. However, in some embodiments, a difference in dimensions between the width of the band and the length of the bonding material as little as 0.5 inches to 1 inch may be sufficient to avoid leaks, depending on the pressure of gas within the cartridge 620.

In the example of FIG. 6, the band 640 extends past an upper edge of the plug 614 by a distance 670. In some embodiments, the portion of the band 640 extending past the upper edge of the plug 614—that is, the region corresponding to distance 670—may be somewhat spaced apart from the outer wall of the elastomeric body 612. In some embodiments, a portion of the band 640 may be crimped, and the crimped region may have a dimension greater than the length 660 of the bonding material 655—that is, an outermost crimp may be outside the upper edge of the bonding material 655.

In FIG. 7, elongation is achieved by decreasing a length of the bonding material. In FIG. 7, the elastomeric body 712 is secured to the plug 714 by bonding material 755, sealing an interior volume 716 of the cartridge 720 to retain pressurized gas therein. A band 740 also secures the elastomeric body 712 to the plug 714. A width of the band 740 is greater than a length 760 of the bonding material 755, which reduces stress at the edge of the bond created by the bonding material 755. For example, a width of the band 740 may be approximately four inches, while the length 760 of the bonding material 755 may be less than approximately three inches. The band 740 extends past an uppermost edge of the bonding material 755 by a distance 770.

With the embodiments of FIGS. 6 and 7, the pressure of gas within the cartridge may be increased by as much as two-third (66%) or more, relative to the embodiment of FIG. 5, without meaningfully increasing the risk of a leak due to stress on the bond. The upper edge of the bands 640, 740 project past the upper edge of the corresponding bonding material 655, 755. Notably, a bottom edge of the band 540, 640, 740 does not present the same risks, and may be offset from a bottom edge of the corresponding bonding material 555, 655, 755 and/or the edge of the corresponding elastomeric body 512, 612, 712, as shown in FIGS. 5, 6, and 7.

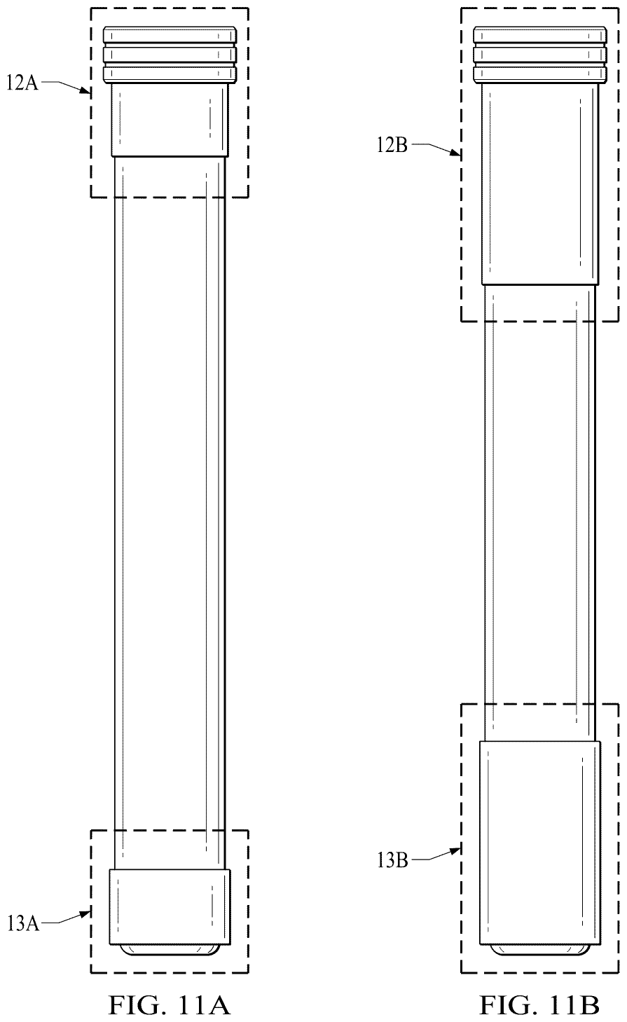

FIGS. 8, 9, and 10 diagrammatically illustrate crimping of a band over bonding material securing the elastomeric body of a cartridge to an insert (plug or head protrusion). Crimping of the band is illustrated independent of relative dimensions of the band relative to an underlying bonding material. While illustrated for a band securing the elastomeric body of a cartridge to a plug as depicted in FIG. 4B, the same issues apply to a band securing the elastomeric body of a cartridge to a protrusion from the head as depicted in FIG. 4A. Accordingly, those skilled in the art will recognize that the same features described in connection with securing the annular, elastomeric body 812, 912, 1012 of a cartridge 820, 920, 1020 to a hollow plug 814, 914, 1014 also apply to securing the other end of the annular, elastomeric body 812, 912, 1012 to a cartridge head (not shown).

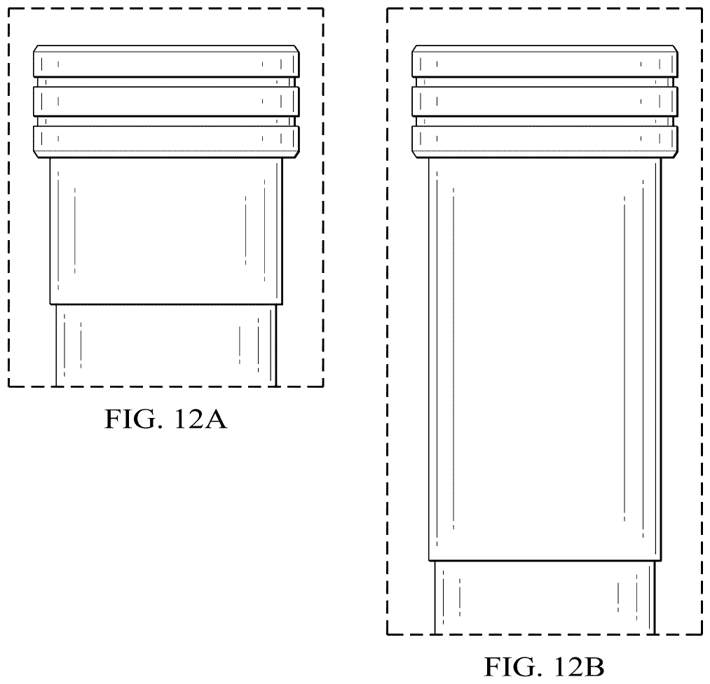

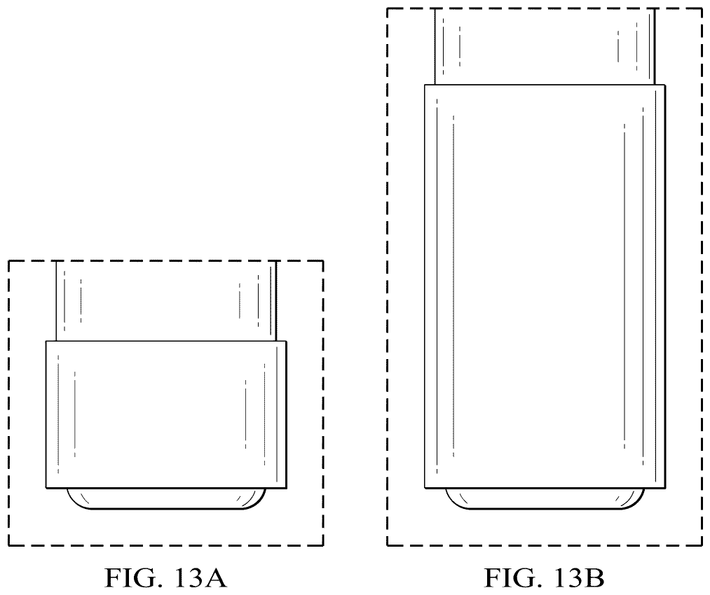

In FIG. 8, the elastomeric body 812 is secured to the plug 814 by bonding material 855 and an overlying band 840 having a crimped portion 841 and an uncrimped portion 842. Likewise, in FIG. 9 and FIG. 10, the elastomeric body 912, 1012 is secured to the respective plug 914, 1014 by bonding material 955, 1055 and an overlying band 940, 1040 having a crimped portion 941, 1041 and an uncrimped portion 942, 1042. However, in FIG. 8, all crimps within the band 840 are inside the edges of the bonding material 855—that is, the endmost crimp 843 (that farthest from the end of the elastomeric body 812 into which the plug 814 is inserted) is inside the innermost edge 856 of the bonding material 855. Stated differently, the endmost crimp 843 is closer to the end of the elastomeric body 812 into which the plug 814 is inserted than the edge 856 of the bonding material 855. By contrast, the endmost crimps 943, 1043 in bands 940, 1040 are “outside” the respective innermost edges 956, 1056 of the corresponding bonding materials 955, 1055—that is, the endmost crimps 943, 1043 are farther from the ends of the elastomeric bodies 912, 1012 into which the plugs 914, 1014 is inserted than the edges 956, 1056 of the bonding materials 955, 1055. Such placement of the outermost crimps 943, 1043 reduces stress at the edge of the bonding material 955, 1055. Notably, shortening the length of the bonding material 955, 1055 (relative to the length of the bonding material 855) may be necessary since mechanical support for the elastomeric body 912, 1012 is required during crimping. Also, as illustrated in FIG. 10, the concepts of both location of the endmost crimp 1043 relative to the edge 1056 of the bonding material 1055 and elongating the band 1040 may be combined to jointly reduce stress that causes one of the bonding material or the annular elastomeric body to tear at or near the innermost edge of the bonding material when the cartridge is pre-charged to a high pressure.

Three other features are illustrated in FIGS. 8, 9, and 10. First, the relative dimensions of the bands 840, 940, 1040 and the bonding materials 855, 955, 1055 described above in connection with FIGS. 5, 6, and 7 may be combined with placement of the endmost crimps 943, 1043. That is, the innermost edge of the uncrimped portion 842 is approximately aligned with the end of the plug 814 in FIG. 8, and close to the innermost edge 856 of the bonding material 855. In extending the dimension of the crimped portions 941, 1041 of the bands 940, 1040 so that the endmost crimp 943, 1043 is outside the edge 956, 1056 of the bonding material 955, 1055, a dimension of the uncrimped portion 942 of the band 940 may be retained as shown in FIG. 9, or the dimension of the uncrimped portion 1042 of the band 1040 may be extended as shown in FIG. 10.

Second, an inner diameter of the uncrimped portion 842, 942, 1042 of the band 840, 940, 1040 may closely approximate the outer diameter of the elastomeric body 812, 912, 1012. The inner diameter of the uncrimped portion 842, 942, 1042 of the band 840, 940, 1040 may be 0% to 5% larger than the outer diameter of the elastomeric body 812, 912, 1012. For different designs, as larger outer diameters for the elastomeric body 812, 912, 1012 are selected, a greater tolerance between the uncrimped portion 842, 942, 1042 of the band 840, 940, 1040 and the elastomeric body 812, 912, 1012 is acceptable. A similar spacing between the inner diameter of the band 540, 640, 740 and the outer diameter of the elastomeric body 512, 612, 712 may be employed in the embodiments of FIGS. 5, 6, and 7.

Third, the outer corner 857, 957, 1057 at the end of the plug 814, 914, 1014 is shown as rounded, to facilitate insertion of the plug into the end of the elastomeric body 812, 912, 1012. Such rounded corners may also be employed on the plugs 514, 614, 714 in the embodiments of FIGS. 5, 6, and 7.

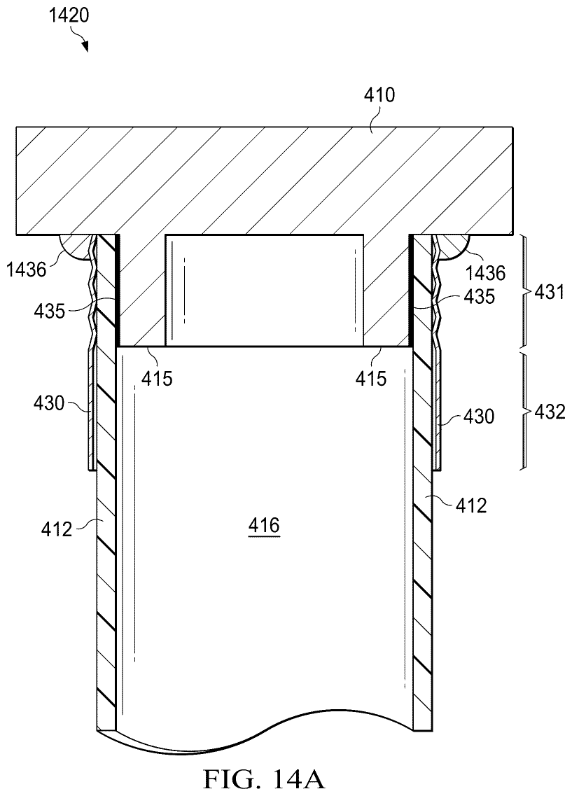

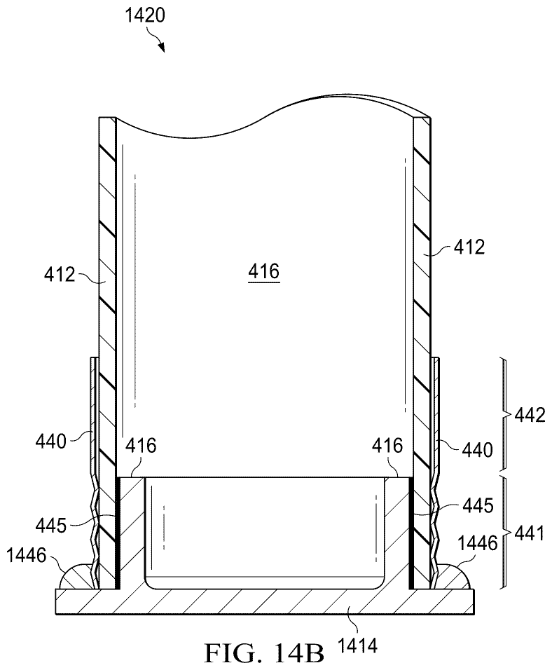

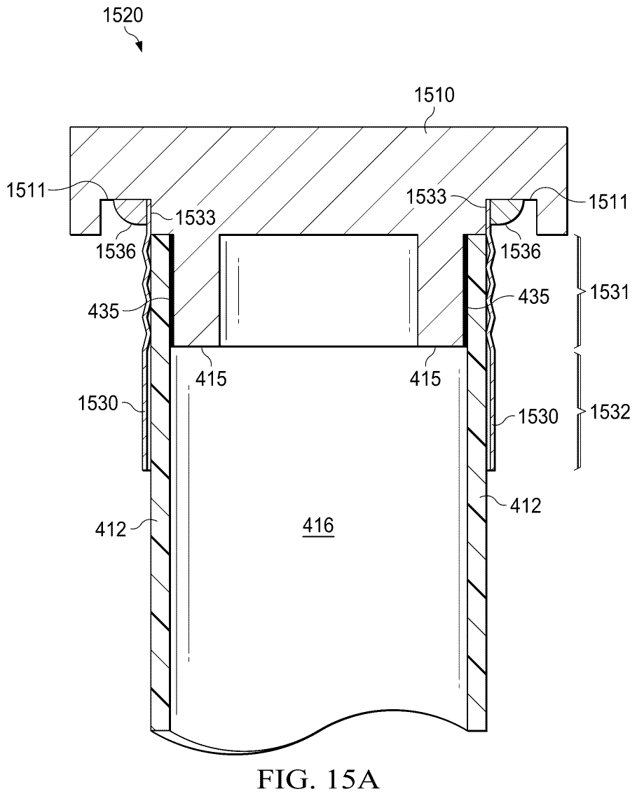

FIGS. 11A and 11B, FIGS. 12A and 12B, and FIGS. 13A and 13B depict comparative embodiments of a pulsation control device cartridge having standard and elongated bands. FIGS. 11A depicts an entire cartridge with a standard width band, FIG. 12A depicts a head end of the cartridge of FIG. 11A, and FIG. 13A depicts a plug end of the cartridge of FIG. 11A. FIG. 11B depicts an entire cartridge with an elongated band, FIG. 12B depicts a head end of the cartridge of FIG. 11B, and FIG. 13B depicts a plug end of the cartridge of FIG. 11B.

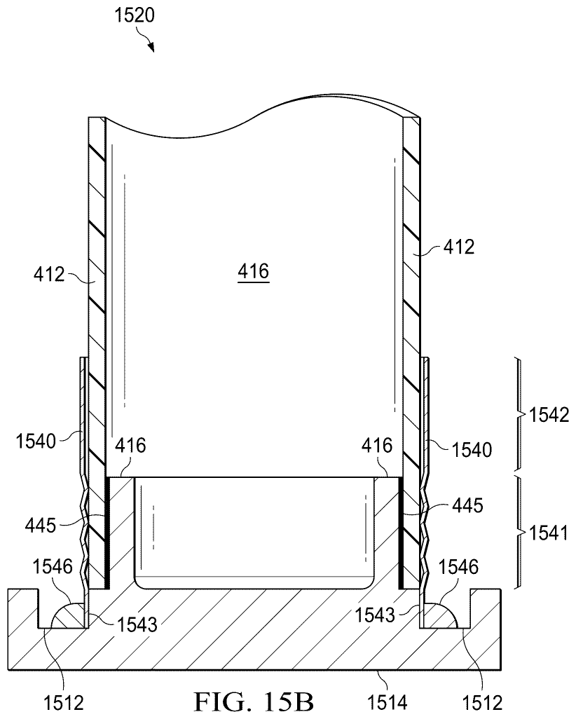

FIGS. 14A and 14B illustrate sectional views of bands on a gas charged cartridge 1420 of the type illustrated in FIGS. 2 and 3 with welds on the bands, for use in a suitable pulsation control device. To contribute to fixing the bands 430 and 440 in position relative to the respective underlying protrusion 415 from the head 410 or plug 1414, welds 1436 and 1446 are used. As shown in FIG. 14B, plug 1414 is formed with flanges. However, bands 430 and 440 need not be modified for this embodiment. A weld 1436 is formed between the flanged portion of the head 410 and band 430, and a weld 1446 is formed between the flanges on plug 1414 and band 440.

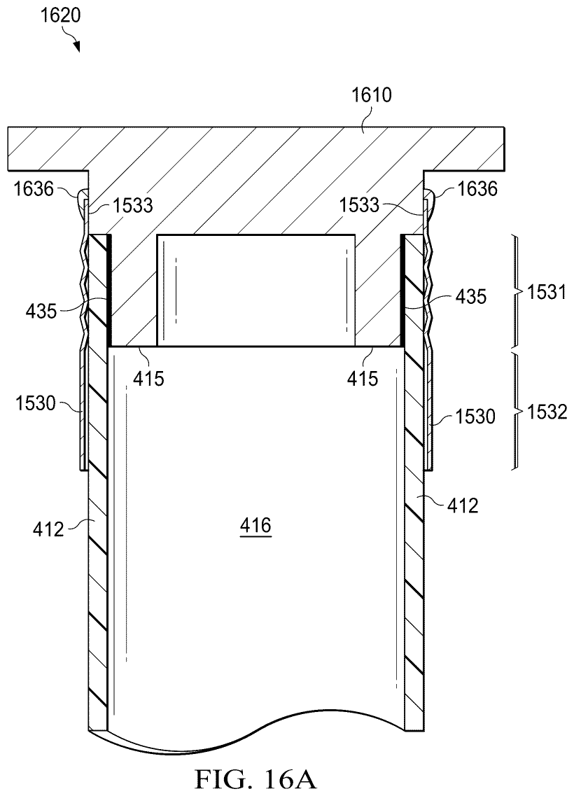

FIGS. 15A and 15B illustrate sectional views of bands on a gas charged cartridge 1520 of the type illustrated in FIGS. 2 and 3 with alternative welds on the bands, for use in a suitable pulsation control device. As shown in FIGS. 15A and 15B, the head 1510 is formed with groove 1511 on the flanged portion thereof, and the plug 1514 is formed with a disk-shaped flange and with a groove 1512 in the flange. Band 1530 is formed with a smooth extension 1533 extending from crimped portion 1531, opposite from elongate smooth portion 1532. Band 1540 is similarly formed with a smooth extension 1543 extending from crimped portion 1541, opposite from elongate smooth portion 1542. A weld 1536 is formed between the bottom of the groove 1511 in the flanged portion of the head 1510 and the extension 1533 of the band 1530. A weld 1546 is formed between the bottom of the groove 1512 in the flange on plug 1514 and the extension 1543 of the band 1540. Grooves 1511 and 1512 are not the only form of recess areas that may be used. For example, counterbores may formed into which the band is extended, to locate the welds and facilitate the welding.

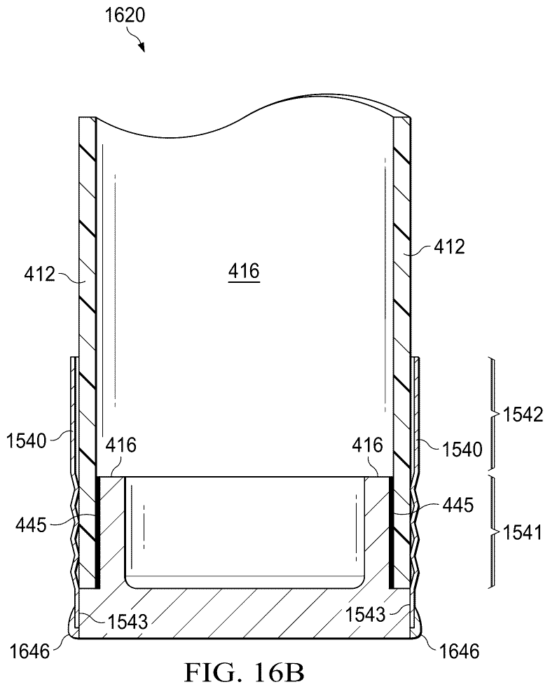

FIGS. 16A and 16B illustrate sectional views of the bands on gas charged cartridges of the type illustrated in FIGS. 2 and 3 with another alternative for welds on the bands, for use in a suitable pulsation control device. As shown in FIG. 16A, the head 1610 is formed with a shoulder between the protrusion 415 and the flanged portion thereof. The same band 1530 shown in FIG. 15A, with a smooth extension 1533 extending from crimped portion 1531, opposite from elongate smooth portion 1532, may be used with the head 1610. The smooth extension 1533 of band 1530 overlies a portion of the shoulder on the head 1610, leaving a cylindrical surface of the head 1610 exposed. A weld 1636 is formed between the exposed cylindrical surface of the head 1610 and the extension 1533 of the band 1530. As shown in FIG. 16B, and the plug 1614 is formed with a stunted flange having a dimension corresponding to a thickness of the elastomeric body 412. The same band 1540 shown in FIG. 15B, with a smooth extension 1543 extending from crimped portion 1541, opposite from elongate smooth portion 1542, may be used with the plug 1614. A weld 1646 is formed between an exposed, outer cylindrical surface of the flange on the plug 1514 and the extension 1543 of the band 1540. The shoulder or outer cylindrical surface on the head 1610 or plug 1614 is provided to be welded to the ends/edges of the cylindrical extensions 1533, 1543. This slightly differs from FIGS. 15A and 15B since the extensions 1533, 1543 are not abutting either the head or plug flanges.

While FIGS. 14A and 14B, FIGS. 15A and 15B, and FIGS. 16A and 16B illustrate show elongate bands, the bands do not have to include smooth portions 432/442 or 1532/1542. Furthermore, the bands may be crimped first, and then welded, or welded first, and then crimped.

Another option is to have one long, perforated band material extending along the entire length of the elastomeric body 412, with regions of that material crimped and welded as described above.

Although the figures illustrate different examples, various changes may be made to the figures. For example, the pulsation control stabilizer can include any number of each component in any suitable arrangement. In general, the figures do not limit the scope of this disclosure to any particular configuration(s). Moreover, while figures illustrate operational environments in which various pulsation control stabilizer features disclosed in this patent document can be used, these features can be used in any other suitable system.

None of the description in this application should be read as implying that any particular element, step, or function is an essential element that must be included in the claim scope. The scope of patented subject matter is defined only by the claims. Moreover, none of the claims is intended to invoke 35 U.S.C. § 112 (f) unless the exact words “means for” are followed by a participle. Use of any other term, including without limitation “mechanism,” “module,” “device,” “unit”, “component”, “element”, “member”, “apparatus”, “machine”, “system”, “processor”, or “controller”, within a claim is understood by the applicants to refer to structures known to those skilled in the relevant art and is not intended to invoke 35 U.S.C. § 112 (f).

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A cartridge for a pulsation control device, the cartridge comprising:
an annular elastomeric body configured to contain a gas pre-charge;
a cylindrical structure inserted into a first end of the annular elastomeric body, the cylindrical structure curved at a portion farthest from the first end of the annular elastomeric body;
a bonding material between the annular elastomeric body and the cylindrical structure and extending across a region between the first end of the annular elastomeric body and a point at which the annular elastomeric body begins to overlie the curved portion of the cylindrical structure, wherein an innermost edge of the bonding material is closest to the curved portion of the cylindrical structure; and
a metallic band around the annular elastomeric body and overlying the bonding material, at least a portion of the metallic band compressing at least one underlying portion of the annular elastomeric body against the cylindrical structure, the metallic band including a crimped portion and an uncrimped portion, with an inner diameter of the uncrimped portion closely approximating an outer diameter of the annular elastomeric body,
wherein at least the uncrimped portion of metallic band extends beyond the region of the bonding material over the annular elastomeric body past the innermost edge of the bonding material, to reduce stress that causes one of the bonding material or the annular elastomeric body to tear at or near the innermost edge of the bonding material when the cartridge is pre-charged.

2. The cartridge of claim 1, wherein the crimped portion of the metallic band ends inside the innermost edge of the bonding material.

3. The cartridge of claim 1, wherein an end crimp within the crimped portion of the metallic band is farther from the first end of the annular elastomeric body than the innermost edge of the bonding material.

4. The cartridge according to claim 1, wherein the cylindrical structure is one of a plug or a protrusion on a cartridge head.

5. The cartridge according to claim 1, wherein an end-most edge of the metallic band is offset from the first end of the annular elastomeric body.

6. The cartridge of claim 1, wherein the uncrimped portion of the metallic band is separated from the annular elastomeric body when the cartridge is not pre-charged.

7. A cartridge for a pulsation control device, the cartridge comprising:
an annular elastomeric body configured to contain a gas pre-charge;
a cylindrical structure inserted into a first end of the annular elastomeric body, the cylindrical structure curved at a portion farthest from the first end of the annular elastomeric body;
a bonding material between the annular elastomeric body and the cylindrical structure and extending across a region between the first end of the annular elastomeric body and a point at which the annular elastomeric body begins to overlie the curved portion of the cylindrical structure, wherein an innermost edge of the bonding material is closest to the curved portion of the cylindrical structure;
a metallic band around the annular elastomeric body and overlying the bonding material, at least a portion of the metallic band compressing at least one underlying portion of the annular elastomeric body against the cylindrical structure, the metallic band including a crimped portion and an uncrimped portion, with an inner diameter of the uncrimped portion closely approximating an outer diameter of the annular elastomeric body; and
a weld between a portion of the metallic band and the cylindrical structure, to reduce shear force on the bonding material.

8. The cartridge of claim 7, wherein the cylindrical structure is a protrusion on a cartridge head, and wherein the weld is between the metallic band and a flange on the cartridge head.

9. The cartridge of claim 8, wherein the weld is between the metallic band and a groove in the flange on the cartridge head.

10. The cartridge of claim 7, wherein the cylindrical structure is a flanged plug, and wherein the weld is between the metallic band and a flange of the plug.

11. The cartridge of claim 10, wherein the weld is between the metallic band and a groove in the flange of the plug.

12. The cartridge of claim 7, wherein the cylindrical structure is a protrusion on a cartridge head, and wherein the weld is between the metallic band and an exposed surface of the protrusion.

13. The cartridge of claim 7, wherein the cylindrical structure is a flanged plug, and wherein the weld is between the metallic band and a circumferential surface of a flange of the plug.

14. A cartridge for a pulsation control device, the cartridge comprising:
an annular elastomeric body configured to contain a gas pre-charge;
a cylindrical structure inserted into a first end of the annular elastomeric body, the cylindrical structure curved at a portion farthest from the first end of the annular elastomeric body;
a bonding material between the annular elastomeric body and the cylindrical structure and extending across a region between the first end of the annular elastomeric body and a point at which the annular elastomeric body begins to overlie the curved portion of the cylindrical structure;
a metallic band around the annular elastomeric body and overlying the bonding material, at least a portion of the metallic band compressing at least one underlying portion of the annular elastomeric body against the cylindrical structure, the metallic band including a plurality of crimps therein, wherein an end-most crimp within the metallic band is farther from the first end of the annular elastomeric body than an edge of the bonding material farthest from the first end of the annular elastomeric body; and
a weld between a portion of the metallic band and the cylindrical structure, to reduce shear force on the bonding material.

15. The cartridge according to claim 14, wherein the cylindrical structure is one of a plug or a protrusion on a cartridge head.

16. The cartridge according to claim 14, wherein an end-most edge of the metallic band is offset from the first end of the annular elastomeric body.

17. The cartridge of claim 14, wherein the metallic band further comprises an uncrimped portion extending from the end-most crimp away from the first end of the annular elastomeric body and having an inner diameter closely approximating an outer diameter of the annular elastomeric body.

18. The cartridge of claim 17, wherein the uncrimped portion of the metallic band is separated from the annular elastomeric body when the cartridge is not pre-charged.

19. The cartridge of claim 14, wherein:
when the cylindrical structure is a protrusion on a cartridge head, the weld is between the metallic band and a flange on the cartridge head, and
when the cylindrical structure is a flanged plug, the weld is between the metallic band and a flange of the plug.
